(19) United States
(12) Patent Application Publication
(10) Pub. No.: US 2016/0151714 A1
(43) Pub. Date: Jun. 2, 2016

(54) SYSTEM AND METHOD FOR DIRECTING A MOVING OBJECT ON AN INTERACTIVE SURFACE

(71) Applicant: Zheng Shi, Beijing (CN)

(72) Inventor: Zheng Shi, Beijing (CN)

(21) Appl. No.: 15/014,042

(22) Filed: Feb. 3, 2016

Related U.S. Application Data
(63) Continuation-in-part of application No. PCT/CN2014/084498, filed on Aug. 15, 2014.
Application No. PCT/CN2014/084498 is a continuation-in-part of application No. PCT/CN2014/079891, filed on Jun. 13, 2014.
Application No. PCT/CN2014/079891 is a continuation-in-part of application No. PCT/CN2014/080495, filed on Jun. 23, 2014.
Application No. PCT/CN2014/080495 is a continuation-in-part of application No. PCT/CN2014/079892, filed on Jun. 13, 2014.

(51) Int. Cl. A63F 13/77; A63F 9/24; A63F 13/235

(52) U.S. Cl. CPC A63F 13/77; A63F 13/235; A63F 9/24; A63F 2009/2489; A63F 2009/2494

(57) ABSTRACT

A system and method for directing the movement of an object on an interactive surface are provided. When an action with respect to a first object is taken by a user on the interactive surface, a processor operatively linked to the interactive surface is configured to direct a second object to move in response to the action of the first user in accordance with user-defined rules.

### CROSS-REFERENCE TO RELATED APPLICATION

This application is a continuation in part of International Patent Application No. PCT/CN2014/084498, entitled “System and Method for Directing a Moving Object on an Interactive Surface”, filed on Aug. 15, 2014, which is a continuation in part of International Patent Application No. PCT/CN2014/079891, entitled “System and Method for Operating a Computer Program with Physical Objects”, filed on Jun. 13, 2014. The International Patent Application No. PCT/CN2014/084498 is also a continuation in part of International Patent Application No. PCT/CN2014/080495, entitled “System and Method to Recognize an Object's ID, Orientation and Location Relative to an Interactive Surface”, filed on Jun. 23, 2014, which is a continuation in part of International Patent Application No. PCT/CN2014/079892, entitled “System and Method for Identifying an Object's ID and Location Relative to an Interactive Surface”, filed on Jun. 13, 2014.

The entire disclosures of each of the above applications are incorporated herein by reference.

### TECHNICAL FIELD

The present invention relates to interaction between users and objects, and more particularly, to systems wherein a second object is moved in response to the action taken with respect to a first object.

### BACKGROUND

The abundance of inexpensive computer processors has greatly influenced recreational and educational games by enabling a high level of interactivity between the user and devices. For instance, many computerized games that enable a human player to play against a computerized opponent have already been developed. Typically, such computerized games provide a visual display of the game activity through an electronic display system to create a dynamic interactive multi-media environment. Unfortunately, such display lacks the three-dimensional nature that allows the physical interaction inherent in traditional board-based games. In addition, almost all computerized games are screen-based and require the players to interact with an electronic screen, whether it is on a laptop computer, a smart phone, or a tablet computer. As a result, users are increasingly exposed to screens from an early age when they use computerized interactive systems for either entertainment or education purpose.

On the other hand, traditional interactive systems may use one or more movable objects that users (especially young ones) find more “natural” and easier to interact with. For example, the conviviality and sensation offered by traditional board games where game pieces can be touched and manipulated is certainly advantageous. However, they often lack audio and/or visual interaction or other forms of sophisticated feedback that computerized games can offer.

Thus, it is desirable to provide a new and innovative game system that negates the use of electronic screens but maintains the power of computer systems to allow for a greater level of interactivity between the user and the system. It is also desirable to provide a system that negates the weakness of traditional interactive systems whilst utilizing their strength. The present invention provides a system for directing moving physical objects on an interactive surface for entertainment, education or productivity purposes. Preferably, such system does not include a screen, but includes a processor so as to fully take advantage of the interactive power provided by the computer system.

### SUMMARY OF THE INVENTION

The present invention provides a novel way of directing movement of a moving object by use of an interactive surface in conjunction with a processor. The interactive surface is configured to recognize the physical objects that have been placed on the surface, and the processor is configured to direct the movement of the moving object in response to the action of a first object.

In accordance with one embodiment of the present invention, a user places a plurality of physical objects on an interactive surface. The physical object can be a chip, a button, a token, a card, a figurine, a block, or a game piece. Each of the physical objects comprises an identifier that comprises the ID information of the object, and at least one object is a moving object embedded with a movement module. An RF antenna, a power source and a micro computer unit (MCU) are further embedded in each moving object, and the MCU is operatively linked to the RF antenna and the movement module. The power source can be a battery or a wireless charging device. Once the physical objects are placed on the interactive surface, the interactive surface is configured to recognize the ID and location and orientation of the physical objects, such as using RFID technology. If any actions are taken on these physical objects, the ID and location and orientation information of the objects can still be tracked by the interactive surface. The action initiated by a first user with respect to an object on the interactive surface can be placing the object on the interactive surface, removing the object away from the interactive surface, changing the location of the object on the interactive surface, or changing the orientation of the object on the interactive surface.

In accordance with one embodiment of the present invention, a processor is operatively linked to the interactive surface. After a plurality of physical objects have been detected and identified by the interactive surface, the processor receives information regarding the physical objects and is configured to process the information.

In accordance with one embodiment of the present invention, once an action by a first user with respect to a first object on the interactive surface is taken, the processor is configured to generate a moving instruction for a moving object, based on the UID and location information of the first object and the moving object and the user-defined rules regarding the objects encoded in a computer program that is operatively linked to the processor and configured to determine the correlation between an action by the first user to the first object and a movement of the moving object. The computer program can be an electronic game, an educational program, or a productivity application, and can be executed either locally or remotely.

In accordance with one embodiment of the present invention, the movement module of the moving object further comprises a moving component such as wheels, legs and roller chains and an electric motor for driving the moving component. The movement module supports the main body of the moving object and provides the movement capability to the moving object. Once a moving instruction for the moving object is generated by the processor, data containing the moving instruction is transmitted by the processor to the moving object via RF communication between the interactive surface and the RF antenna embedded in the moving object. The data is then processed by the MCU embedded in the moving object and the instruction is sent to the movement module. Driven by the electric motor, the moving component moves the moving object on the interactive surface.

In accordance with one embodiment of the present invention, the computer program is also configured to take an input from an action of a second user before the processor generates the moving instruction for the moving object, if applicable. In this case, the second user could be physically in a different location from the first user.

### BRIEF DESCRIPTION OF THE DRAWINGS

FIG. 1 is an exemplary schematic diagram illustrating the system process flow in accordance with one embodiment of the present invention.

FIG. 2 is an exemplary schematic diagram of the system for an interactive board game in accordance with one embodiment of the present invention.

FIG. 3 is an exemplary schematic diagram of the system for the CHESS game in accordance with one embodiment of the present invention.

FIGS. 4A and 4B are exemplary schematic diagrams of the system for an educational program in accordance with one embodiment of the present invention.

FIGS. 5A and 5B are exemplary schematic diagrams for a productivity application in accordance with one embodiment of the present invention.

### DETAILED DESCRIPTION OF THE INVENTION

Reference will now be made in detail to various embodiments of the invention, examples of which are illustrated in the accompanying drawings. While the invention will be described in conjunction with the embodiments, it will be understood that this is not intended to limit the scope of the invention to these specific embodiments. The invention is intended to cover all alternatives, modifications and equivalents within the spirit and scope of invention, which is defined by the apprehended claims.

Furthermore, in the detailed description of the present invention, specific details are set forth in order to provide a thorough understanding of the present invention. However, it will be obvious to one of ordinary skill in the art that the present invention may be practiced without these specific details. In other instances, well known methods, procedures, components, and circuits are not described in details to avoid unnecessarily obscuring a clear understanding of the present invention.

The present invention may be better understood and its numerous objectives and advantages will become apparent to those skilled in the art by reference to the accompanying drawings.

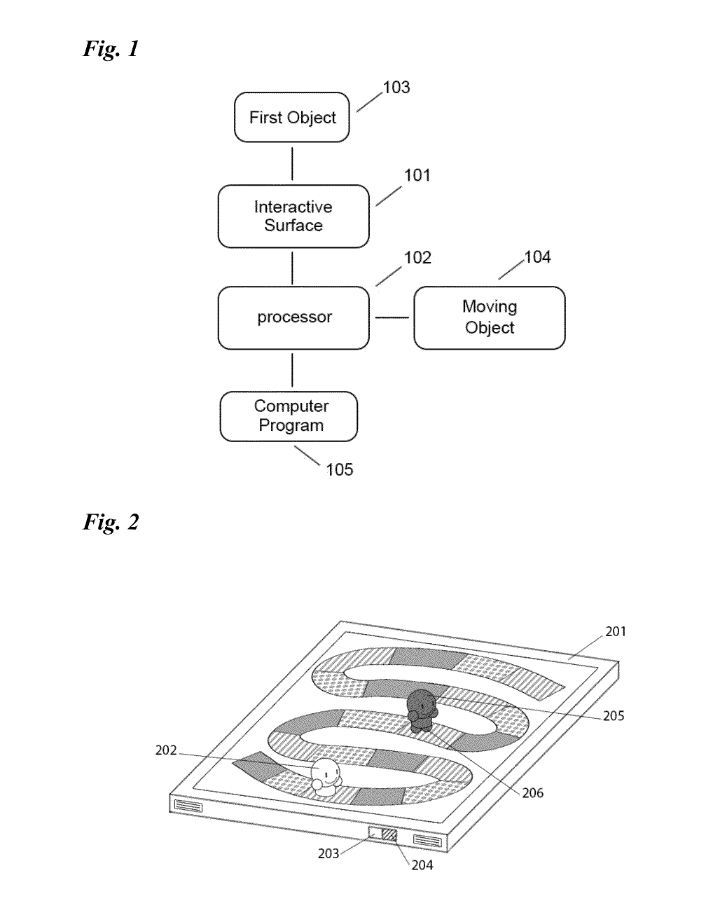

The embodiments of the present invention provide a system and method for directing a moving object by use of an interactive surface in conjunction with a processor. FIG. 1 is an exemplary schematic diagram illustrating the system process flow in accordance with one embodiment of the present invention. As shown in FIG. 1, the system includes an interactive surface 101 that is operatively linked to a processor 102 and is configured to detect the location and unique ID of a first object 103 placed on or near the interactive surface 101. The processor 102 is configured to generate a moving instruction for a moving object 104 based on the UID and location information of the objects and user-defined rules, and direct the moving object 104 to move in accordance with the moving instruction from a computer program 105 encoding the user-defined rules regarding the objects and to be executed by the processor 102.

The physical objects could include chips, buttons, tokens, cards, figurines, blocks, and game pieces. The identifier of the object includes a unique identification code (UID), and the UID can be encoded with a radio frequency identification chip, a pattern of capacitive tabs, or a pattern of magnetic tabs.

FIG. 2 is an exemplary schematic diagram of the system for an interactive board game in accordance with one embodiment of the present invention, which illustrates the process of movement of moving game pieces using the system design in FIG. 1. For the sake of illustration, although both the system and method described in FIG. 2 are designed specifically to play the simple but classic interactive board game CANDYLAND, any person skilled in the art will recognize that this embodiment has a large number of uses and designs, and can be easily adapted to a variety of different games.

As shown in FIG. 2, a first game piece 202 and a moving game piece 205 are placed on the interactive surface 201. Once the first game piece 202 is placed on the interactive surface 201, which also serves as the game map, the interactive surface 201 detects the ID of the first game piece 202 as well as its relative location and orientation on the interactive surface 201 and transmits this information to the processor 203 that is operatively linked to the interactive surface 201. If any action is taken on the first game piece 202 by a user, such as moving to another location on the interactive surface 201, its ID and location and orientation information will still be detected by the interactive surface 201 and transmitted to the processor 203. The processor 203 is then configured to process the information and generate a moving instruction for the moving game piece 205, based on the UID and location information of these objects 202 and 205 and the user-defined rules regarding the objects encoded in a computer program 204 that is operatively linked to the processor 203. In this example, the computer program 204 is defined based on the rules of the game CANDYLAND and executed locally to determine the correlation between the movement of the first game piece 202 and the movement of the moving game piece 205 that belongs to a computerized opponent of the user.

To facilitate its movement, the moving game piece 205 includes a movement module 206 as well as a power source and a micro computer unit (MCU) that is operatively linked to the RF antenna and the movement module 206. The movement module 206 further includes a moving component selected from wheels, legs and roller chains and a motor for driving the moving component. The power source can be a battery or a wireless charging device. Once a moving instruction for the moving game piece 205 is generated by processor 203, the data containing the instruction is transmitted by the processor 203 to the moving game piece 205 via RF communication between the interactive surface 201 and the RF antenna embedded in the moving game piece 205. The data is then processed by the MCU embedded in the moving game piece 205 and the instruction is sent to the movement module 206. Driven by the electric motor, the moving component moves the moving game piece 205 to a location on the interactive surface 201 in response to the action of the first game piece 202.

Once the moving game piece 205 makes a move, the user can make the next move with the first game piece 202. Thus, with the first game piece 202 and the moving game piece 205 moving alternatively on the interactive surface 201, the board game CANDYLAND can be played until the winner reaches the candy castle at the end of the path.

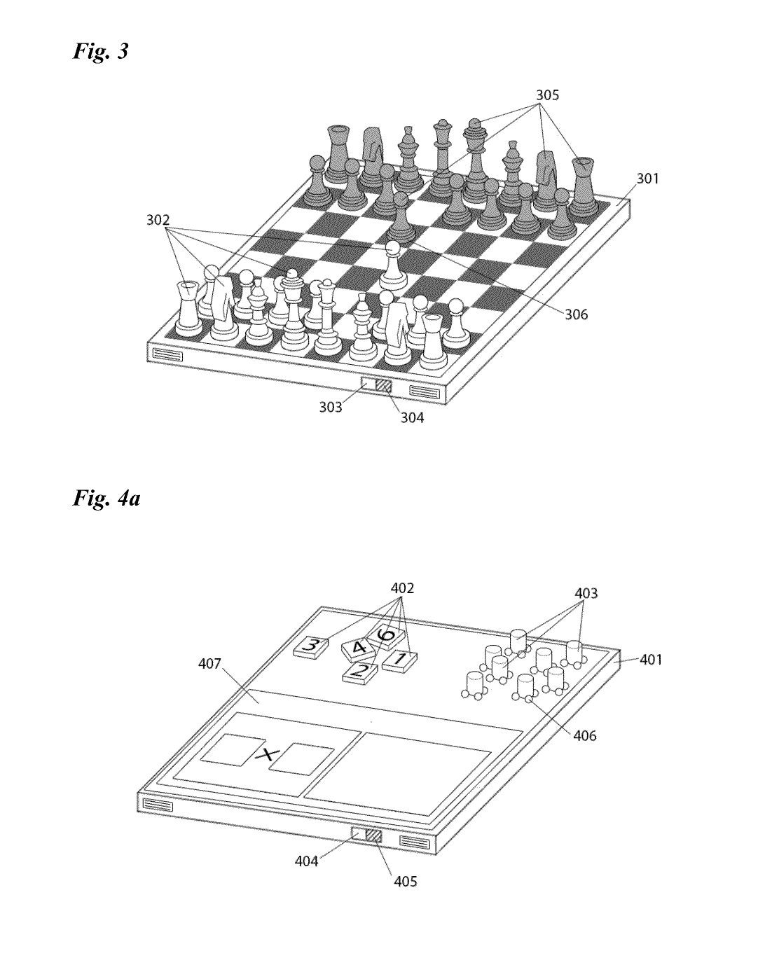

FIG. 3 is an exemplary schematic diagram of the system for the CHESS game in accordance with one embodiment of the present invention. As shown in FIG. 3, a plurality of chessmen 302 and moving chessmen 305 are placed on the interactive surface 301. Once a plurality of chessmen 302 are placed on the interactive surface 301, which also serves as the chess board, the interactive surface 301 detects the IDs of the chessmen 302 as well as their relative location and orientation on the interactive surface 301 and transmits this information to the processor 303 that is operatively linked to the interactive surface 301. If any action is taken on any of the chessmen 302 by a first player, such as moving to another location on the interactive surface 301, its ID and location and orientation information will still be detected by the interactive surface 301 and transmitted to the processor 303. The processor 303 is then configured to process the information and generate a moving instruction for the moving chessmen 305, based on the UID and location information of these objects 302 and 305 and the user-defined rules regarding the objects encoded in a computer program 304 that is operatively linked to the processor 303. In this example, the computer program 304 is defined based on the rules of the CHESS game and executed to determine the correlation between the movement of the chessman 302 and the counter-move of any selected moving chessmen 305, and is configured to take an input from the action of a second player who is physically in a different location from the first player. The input of the second player could be provided remotely, such as via the internet. Once the moving instruction for the counter-move of the selected moving chessmen 305 is generated by the processor 303, the moving chessmen 305 is directed by the processor 303 to move to a location on the interactive surface 301 in response to the move of the first chessman 302, by RF communication between the interactive surface 301 and the RF antenna embedded in the moving chessman 305.

To make the movement of a moving chessman 305 possible, each moving chessman 305 further includes a movement module 306 as well as a power source and a micro computer unit (MCU) that is operatively linked to the RF antenna and the movement module 306. The movement module 306 further includes a moving component selected from wheels, legs and roller chains and a motor for driving the moving component. Once the second player makes a counter-move with the moving chessman 305, the first player can make a next move of chessman 302. Thus, with chessman 302 and moving chessman 305 moving alternatively on the interactive chessboard 301, the CHESS game can be played.

It should be further noticed that, if the second player is provided with the same game apparatus as the first player, i.e., the interactive surface 301, the chessmen 302 and the moving chessmen 305, the play of the CHESS game for the first player will be completely mirrored to that for the second player. In another word, multiple identical games can be run simultaneously at different locations.

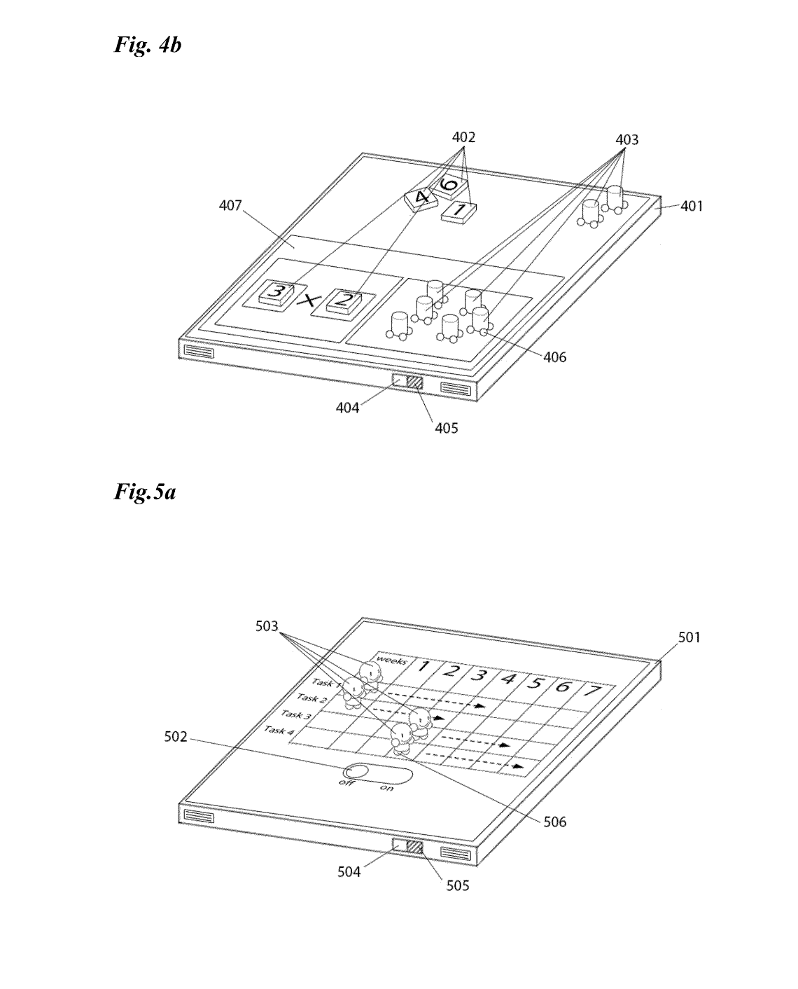

FIGS. 4A and 4B are exemplary schematic diagrams of the system for an educational game in accordance with one embodiment of the present invention. For the sake of illustration, although both the system and method described in FIG. 4 are designed specifically to present the process of learning multiplication, any person skilled in the art will recognize that this embodiment has a large number of uses and designs, and can be easily adapted to a variety of learning processes.

As shown in FIG. 4A, objects that fall into two categories are placed on the interactive surface 401. Placed on the top left corner of the interactive surface 401 are cards 402 printed with natural numbers. Placed on the top right corner are moving blocks 403 equipped with a movement module 406 as well as an RF antenna, a power source and a micro computer unit (MCU) that is operatively linked to the RF antenna and the movement module 406. The movement module 406 further includes a moving component selected from wheels, legs and roller chains and a motor for driving the moving component. Once a card 402 is placed on the interactive surface 401, its ID as well as its relative location and orientation on the interactive surface 401 is detected by the interactive surface 401 and the information is transmitted to the processor 404 that is operatively linked to the interactive surface 401.

As shown in FIG. 4B, if any action is taken on cards 402 by a user, such as moving to the working area 407 on the bottom half of the interactive surface 401, their ID and location and orientation information will still be detected by the interactive surface 401 and transmitted to the processor 404. The processor 404 is configured to process the information and generate a moving instruction for the moving blocks 403, based on the UID and location information of these objects 402 and 403 and the user-defined rules regarding the objects encoded in a computer program 405 that is operatively linked to the processor 404. In this example, the computer program 405 is defined based on an educational program and executed locally to determine the correlation between the action of cards 402 and the movements of the moving blocks 403. Specifically, in this embodiment which aims to help users, preferably children under the age of six, better understand and learn multiplication, one of the basic mathematical operation of arithmetic, the computer program 405 is defined based on the rule of multiplication. Multiplication involves a multiplicand, the number to be multiplied, and a multiplier, the number of multiples. Therefore, in this embodiment, two cards are used to represent the multiplicand and the multiplier respectively. When a multiplicand card 402 printed with a natural number 3 is moved into the working area 407 on the interactive surface 401, as shown in FIG. 4B, 3 moving blocks 403 are directed by the processor 404 to move into the working area 407 accordingly, by RF communication between the interactive surface 401 and the RF antennas embedded in these moving blocks 403. When a multiplier card 402 printed with a natural number 2 is moved into the working area 407 on the interactive surface 401, the processor 404 instructs that three moving blocks 403 shall be moved into the working area 407 twice. As a result, a total of six moving blocks 403, three each time, are directed by the processor 404 to move into the working area 407, in response to actions of the cards 402, to complete the simple multiplication “3×2=6”.

As illustrated in FIGS. 4A and 4B, with the system and method for directing moving objects on the interactive surface, the user is provided with a straightforward and lively method to understand and learn an abstract arithmetic calculation.

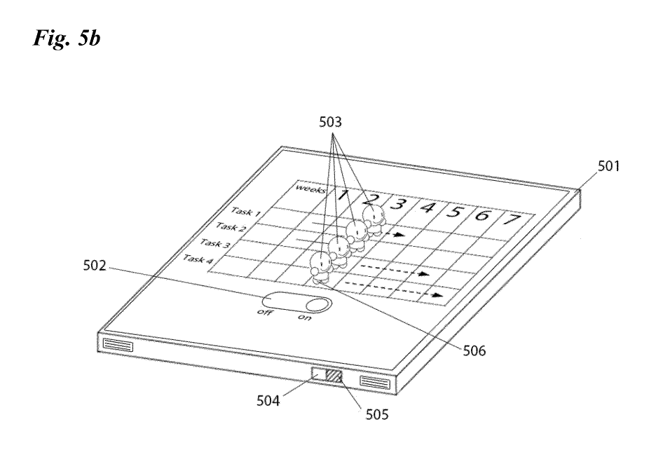

FIGS. 5A and 5B are exemplary schematic diagrams of the system for a productivity application in accordance with one embodiment of the present invention.

In this embodiment, two types of objects are used to illustrate the actual progress of a project. Specifically, as shown in FIGS. 5A and 5B, placed on the interactive surface 501 are a button 502 and a plurality of moving figurines 503 each equipped with a movement module 506 to move itself on the interactive surface 501. An RF antenna, a power source and a micro computer unit (MCU) are embedded in each moving object, and the MCU is operatively linked to the RF antenna and the movement module 506. Once the button 502 is placed on the interactive surface 501, its ID as well as its relative location and orientation on the interactive surface 501 is detected by the interactive surface 501 and the information is transmitted to the processor 504 that is operatively linked to the interactive surface 501.

As shown in FIG. 5A, if any action is taken on the button 502, such as being switched from the position “off” to “on”, its ID and location and orientation information will still be detected by the interactive surface 501 and transmitted to the processor 504. The processor 504 is then configured to process the information and generate a moving instruction for the moving figurines 503, based on the UID and location information of these objects 502 and 503 and the user-defined rules regarding the objects encoded in a computer program 505 that is operatively linked to the processor 504. In this example, the computer program 505 is defined based on the requirements of this productivity application so as to enable it to access the information related to the latest progress of various tasks of the project and to take this information as input to generate the moving instruction for all moving figurines 503 that represent different tasks of the project. Once the moving instruction for a particular moving figurine 503 representing a certain task of the project is generated by the processor 504, the moving figurine 503 is directed by the processor 504 to move in response to the action of the button 502 via RF communication between the interactive surface and the RF antenna embedded in the moving figurine 503.

As shown in FIG. 5B, figurines 502 that represent tasks 1 and 2 that are expected to start at the very beginning of the project are moved first in response to the action of button 502. Other figurines 502, such as those that represent tasks 3 and 4, will not make any movement until the movement of the figurine that represents task 2 is completed, as per the computer program 505. Once the button 502 is moved, the progress of the project will be illustrated real time in a non-traditional and more straightforward manner with the system and method introduced.

A method for directing a moving object by use of an interactive surface is broken into several steps in accordance with another embodiment of the present invention. The method in this embodiment may be implemented in the system embodiment shown in FIG. 1.

Step i: placing a plurality of objects on or near an interactive surface, and each object is embedded with a unique identification code (UID).

Step ii: recognizing the UID and location information of the plurality of objects placed on or near the interactive surface, by the interactive surface.

Step iii: initiating an action by a first user with respect to a first object among the plurality of objects.

Step iv: generating a moving instruction for a second object based on the UID and location information of the first object and the second object and user-defined rules regarding the objects, by a processor. The user-defined rules are encoded in a computer program that is operatively linked to the processor and executed by the processor.

Step v: directing the second object to move in accordance with the instruction, by the processor.

1. A system for directing the movement of an object on an interactive surface, comprising:
a plurality of objects, each object embedded with a unique identification code (UID);
an interactive surface configured to recognize the UID and location information of an object placed on or near the interactive surface;
a processor operatively linked to the interactive surface and configured to execute a computer program encoding user-defined rules regarding the objects;
wherein, upon an action having been initiated by a first user with respect to a first object, the processor is configured to generate a moving instruction for a second object based on the UID and location information of the objects and the user-defined rules, and direct the second object to move in accordance with the instruction.

2. The system of claim 1, wherein the second object is embedded with a movement module for moving the second object.

3. The system of claim 2, wherein the movement module further comprises a moving component selected from a group consisting of wheels, legs and roller chains, and a motor for driving the moving component.

4. The system of claim 2, wherein the second object is embedded with an RF antenna, a power source and a micro-computer unit (MCU) operatively linked to the RF antenna and the movement module.

5. The system of claim 4, wherein the processor is configured to direct the second object to move by RF communication between the interactive surface and the RF antenna embedded in the second object.

6. The system of claim 4, wherein the power source is selected from a group consisting of a battery and a wireless charging device.

7. The system of claim 1, wherein the action with respect to the first object is selected from a group comprising placing the first object on the interactive surface, removing the first object away from the interactive surface, changing the location of the first object on the interactive surface, and changing the orientation of the first object on the interactive surface.

8. The system of claim 1, wherein the first object is selected from a group comprising a chip, a button, a token, a card, a figurine, a block, and a game piece.

9. The system of claim 1, wherein the computer program is executed remotely.

10. The system of claim 1, wherein the computer program is configured to receive an input from a second user remotely regarding the movement of the second object.

11. A method for directing the movement of an object on an interactive surface, comprising:
placing a plurality of objects on or near an interactive surface, each object embedded with a unique identification code (UID);
recognizing the UID and location information of the plurality of objects placed on or near the interactive surface;
initiating an action by a first user with respect to a first object;
generating a moving instruction for a second object based on the UID and location information of the objects and user-defined rules; and
directing the second object to move in accordance with the instruction.

12. The method of claim 11, wherein the second object is embedded with a movement module for moving the second object.

13. The method of claim 12, wherein the movement module further comprises a moving component selected from a group consisting of wheels, legs and roller chains, and a motor for driving the moving component.

14. The method of claim 12, wherein the second object is embedded with an RF antenna, a power source and a micro-computer unit (MCU) operatively linked to the RF antenna and the movement module.

15. The method of claim 14, further comprising directing the second object to move by RF communication between the interactive surface and the RF antenna embedded in the second object.

16. The method of claim 14, wherein the power source is selected from a group consisting of a battery and a wireless charging device.

17. The method of claim 11, wherein the action with respect to the first object is selected from a group comprising placing the first object on the interactive surface, removing the first object away from the interactive surface, changing the location of the first object on the interactive surface, and changing the orientation of the first object on the interactive surface.

18. The method of claim 11, wherein the first object is selected from a group comprising a chip, a button, a token, a card, a figurine, a block, and a game piece.

19. The method of claim 11, wherein the step of directing the second object to move comprises directing the second object to move by a computer program executed remotely.

20. The method of claim 11, further comprising receiving an input from a second user remotely regarding the movement of the second object.
